(19) United States
(12) Patent Application Publication
(10) Pub. No.: US 2018/0179477 A1
(43) Pub. Date: Jun. 28, 2018

(54) WATER-SOLUBLE UNIT DOSE ARTICLE COMPRISING ETHOXYLATED POLYETHYLENEIMINE

(71) Applicant: The Procter & Gamble Company, Cincinnati, OH (US)

(72) Inventors: Colin Ure, Tyne & Wear (GB); Alan Thomas Brooker, Newcastle upon Tyne (GB); Nigel Patrick Somerville Roberts, Newcastle upon Tyne (GB); Robby Renilde Francois Keuleers, Lippelo (BE)

(21) Appl. No.: 15/838,482

(22) Filed: Dec. 12, 2017

(30) Foreign Application Priority Data
Dec. 28, 2016 (EP) 16207066.8
Sep. 1, 2017 (EP) 17189012.2

(51) Int. Cl. C11D 17/04; C11D 1/14; C11D 1/722; C11D 3/37; C11D 3/22; C11D 9/26; C08L 29/04

(52) U.S. Cl. CPC C11D 17/045; C11D 17/044; C11D 1/143; C11D 1/146; C08L 29/04; C11D 3/3723; C11D 3/22; C11D 9/267; C11D 1/722

(57) ABSTRACT

The present disclosure is to a water-soluble unit dose article comprising a laundry detergent composition wherein the detergent contains an ethoxylated polyethyleneimine, and methods of using said unit dose article.

### FIELD OF THE INVENTION

The present invention is to a water-soluble unit dose article comprising a laundry detergent composition wherein the detergent comprises an ethoxylated polyethyleneimine, and methods of using said unit dose article.

### BACKGROUND OF THE INVENTION

Water-soluble unit dose articles are liked by consumers due to their convenience and ease of use during the laundry operation.

Such water-soluble unit dose articles often comprise laundry detergent compositions. Non-soap surfactants are added to provide cleaning benefits. However, due to the compact nature of unit dose articles, there is finite space available for formulating actives into the composition. Therefore, there is a desire to reduce the overall levels of non-soap surfactant used, as non-soap surfactants tend to account for approximately 40% to 50% by weight of the detergent composition. However, removal of non-soap surfactants can detrimentally affect cleaning performance.

WO 2009153184 and EP 2476743B1 teach low non-soap surfactant compositions in which low level of cleaning performance is compensated by addition of ethoxylated polyethyleneimines. Despite this, there remains a desire to further improve the cleaning benefit in low non-soap surfactant water-soluble unit dose formulations above that seen in the prior art.

It was surprisingly found that increasing levels of fatty acid, neutralized fatty acid soap or a mixture thereof improved the cleaning efficacy of ethoxylated polyethyleneimine containing low non-soap surfactant water-soluble unit dose compositions, especially particulate soil removal from fabrics.

### SUMMARY OF THE INVENTION

A first aspect of the present invention is a water-soluble unit dose article comprising a water-soluble film and a laundry detergent composition, wherein said detergent composition comprises;
a. a first polymer selected from an ethoxylated polyethyleneimine, preferably wherein the laundry detergent composition comprises between 0.5% and 10%, preferably between 1% and 7.5%, more preferably between 2% and 6%, most preferably between 3% and 5% by weight of the laundry detergent composition of the ethoxylated polyethyleneimine; and
b. between 3% and 20%, preferably between 5% and 17%, preferably between 6% and 15%, more preferably between 8% and 13% by weight of the laundry detergent composition of the fatty acid, neutralised fatty acid soap or a mixture thereof wherein the neutralised fatty acid soap is alkali metal neutralised, amine neutralised or a mixture thereof;
c. between 10% and 40% preferably between 12% and 37%, more preferably between 15% and 35% by weight of the laundry detergent composition of a non-soap surfactant; and
   wherein said ethoxylated polyethyleneimine is selected from an ethoxylated polyethyleneimine wherein;
      the polyethyleneimine backbone has a weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol;
      an average of 5 to 40, preferably 10 to 30, more preferably 15 to 25 or most preferably 18 to 22 ethoxy units per ethoxylation chain;
      the ethoxylated polyethyleneimine has a total weight average molecular weight of from about 5000 g/mol to about 20000 g/mol, preferably from about 7500 g/mol to about 17500 g/mol, more preferably from about 10000 g/mol to about 15000 g/mol, most preferably from about 12000 g/mol to about 13000 g/mol;
      wherein the terminal ethoxy moiety of the ethoxylation modification is capped with hydrogen, a C₁-C₄ alkyl or mixtures thereof, preferably hydrogen; the degree of permanent quaternization being from about 0% to about 30% of the polyethyleneimine backbone nitrogen atoms, preferably 0%.
         A second aspect of the present invention is a process for washing fabrics comprising the steps of;
a. Combining a water-soluble unit dose article according to the present invention with sufficient water to dissolve the water-soluble film and dilute the laundry detergent composition by a factor of between 300 and 800-fold to form a wash liquor;
b. Combining the wash liquor with at least one fabric to be washed.

A third aspect of the present invention is the use of fatty acid, neutralized fatty acid soap or a mixture thereof to improve fabric cleaning performance of an ethoxylated polyethyleneimine, especially in laundry detergent compositions comprising between 10% and 35% by weight of the laundry detergent composition of a non-soap surfactant.

### BRIEF DESCRIPTION OF THE DRAWING

FIG. 1 is a water-soluble unit dose article according to the present invention.

### DETAILED DESCRIPTION OF THE INVENTION

### Water-Soluble Unit Dose Article

The present invention discloses a water-soluble unit dose article comprising a water-soluble film and a laundry detergent composition. The laundry detergent composition is described in more detail below. The water-soluble film is described in more detail below.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation, the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

The water-soluble unit dose article may comprise at least two compartments, preferably at least three compartments, wherein the laundry detergent composition is comprised within at least one compartment. The laundry detergent composition may represent a culmination of ingredients located within all the compartments of the unit dose article.

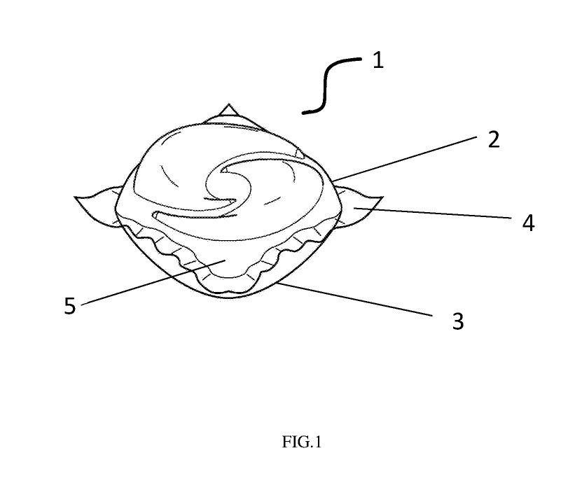

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

### Laundry Detergent Composition

The water-soluble unit dose article comprises a laundry detergent composition. The laundry detergent composition, may be a liquid, a solid or a mixture thereof.

The term ‘solid laundry detergent composition’ refers to any laundry detergent composition that is solid. Solid can include, particles, compressed solids or a mixture thereof.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid detergent composition can be used in a fabric hand wash operation or may be used in an automatic machine fabric wash operation.

The laundry detergent composition comprises a first polymer selected from an ethoxylated polyethyleneimine. The ethoxylated polyethyleneimine is described in more detail below. The laundry detergent composition may comprise between 0.5% and 10%, preferably between 1% and 7.5%, more preferably between 2% and 6%, most preferably between 3% and 5% by weight of the laundry detergent composition of the ethoxylated polyethyleneimine.

The laundry detergent composition comprises between 3% and 20% by weight of the laundry detergent composition of a fatty acid, a neutralized fatty acid soap or a mixture thereof. Preferably, the laundry detergent composition comprises between 5% and 17%, preferably between 6% and 15%, more preferably between 8% and 13% by weight of the laundry detergent composition of the fatty acid, neutralized fatty acid soap or a mixture thereof.

The neutralized fatty acid soap may be alkali metal neutralized, amine neutralized or a mixture thereof. The alkali metal may be selected from sodium, potassium, magnesium or a mixture thereof, preferably sodium. The amine is preferably an alkanolamine, preferably selected from monethanolamine, diethanolamine, triethanolamine or a mixture thereof, more preferably monoethanolamine.

The fatty acid, neutralized fatty acid soap or mixture thereof may be selected from palm kernel fatty acid, coconut fatty acid, rapeseed fatty acid, neutralized palm kernel fatty acid, neutralized coconut fatty acid, neutralized rapeseed fatty acid, or mixture thereof.

Preferably, the weight ratio of neutralized fatty acid soap to fatty acid is higher than 5:1 preferably higher than 7:1, more preferably higher than 10:1.

The laundry detergent composition comprises between 10% and 40% preferably between 12% and 37%, more preferably between 15% and 35% by weight of the laundry detergent composition of a non-soap surfactant, preferably selected from the list of anionic non-soap surfactants, non-ionic surfactants, and mixtures thereof.

Preferably, the non-ionic surfactant is selected from alcohol alkoxylate, an oxo-synthesized alcohol alkoxylate, Guerbet alcohol alkoxylates, alkyl phenol alcohol alkoxylates or a mixture thereof.

Suitable alcohol ethoxylate nonionic surfactants include the condensation products of aliphatic alcohols with from 1 to 25 moles of ethylene oxide. The alkyl chain of the aliphatic alcohol can either be straight or branched, guerbet, primary or secondary, and generally contains from 8 to 22 carbon atoms. The starting alcohol can be naturally derived, e.g. starting from natural oils, or synthetically derived, e.g. alcohols obtained from for example oxo-, modified oxo- or Fischer-Tropsch processes. Examples of oxo-process derived alcohols include the Lial and Isalchem alcohols ex Sasol company and Lutensol alcohols ex BASF company. Examples of modified-oxo process derived alcohols include the Neodol alcohols ex Shell company. Fischer-Tropsch derived alcohols include Safol alcohols ex Sasol company. The alkoxylate chain of alcohol ethoxylates is made up solely of ethoxylate groups.

Preferably, the alcohol ethoxylate non-ionic surfactant comprises on average between 8 and 18, more preferably between 10 and 16 even more preferably between 12 and 15 carbon atoms in the alcohol carbon chain, and on average between 5 and 12, preferably between 6 and 10, more preferably between 7 and 8 ethoxy units in the ethoxylation chain.

Preferably, the non-soap surfactant comprises linear alkylbenzene sulphonate and wherein the laundry detergent composition comprises between 5% and 20%, preferably between 10% and 17% by weight of the laundry detergent composition of the linear alkylbenzene sulphonate.

Preferably, the non-soap surfactant comprises an alkyl sulphate, alkoxylated alkyl sulphate or a mixture thereof and wherein the laundry detergent composition comprises between 5% and 20%, preferably between 7% and 18%, more preferably between 10% and 17% by weight of the alkyl sulphate, alkoxylated alkyl sulphate or a mixture thereof. Preferably, the alkoxylated alkyl sulphate is an ethoxylated alkyl sulphate with an average degree of ethoxylation of between 0.5 and 7, preferably between 1 and 5, more preferably between 2 and 4, most preferably about 3. Alternatively, the non-soap surfactant comprises a mixture of one or more alkoxylated alkyl sulphates, preferably ethoxylated alkyl sulphates, and optionally an alkyl sulphate, the mixture having an average degree of ethoxylation of between 0.5 and 7, preferably between 1 and 5, more preferably between 2 and 4, most preferably about 3.

Preferably, the weight ratio of alkoxylated alkyl sulphate to linear alkylbenzene sulphonate is from 2:1 to 1:8 preferably from 1:1 to 1:5 most preferably from 1:1.25 to 1:4.

Preferably, the weight ratio of non-soap anionic surfactant to non-ionic surfactant is from 1:1 to 40:1, preferably from 1:1 to 20:1, more preferably from 1.3:1 to 15:1, even more preferably from 1.5:1 to 10:1.

Preferably, the laundry detergent composition comprises between 10% and 60%, preferably between 12% and 50%, most preferably between 15% and 40% by weight of the laundry detergent composition of a non-aqueous solvent. Preferably, the non-aqueous solvent is selected from 1,2-Propanediol, glycerol, sorbitol, dipropylene glycol, tripropyleneglycol, polypropylene glycol or a mixture thereof.

Preferably, the water-soluble unit dose article comprises 15% or less by weight of the unit dose article of water, preferably the unit dose article comprises between 0.1% and 15%, more preferably between 1% and 12.5% by weight of the unit dose article of water.

The laundry detergent composition may comprise a second polymer selected from amphiphilic graft copolymers, carboxymethyl cellulose, modified carboxymethylcellulose, polyester terephthalate polymers, hydroxyethylcellulose, modified hydroxyethylcellulose or a mixture thereof. Especially preferred are cationic modified hydroxyethylcellulose. Preferably, the laundry detergent composition comprises between 0.5% and 10%, preferably between 0.75% and 7%, more preferably between 1.5% and 5% by weight of the laundry detergent composition of the second polymer.

The water-soluble unit dose article may comprise between 0.01% to about 20%, preferably from 0.1% to 10%, more preferably from 0.5% to 7%, even more preferably from 1% to 5%, most preferably from 2% to 4% by weight of the laundry detergent composition of a zwitterionic polyamine, preferably an ethoxylated zwitterionic hexamethylene diamine, more preferably a zwitterionic hexamethylene diamine represented by the following formula:

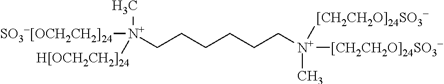

in which approximately 40% of the polyethoxy groups are sulfonated, the remaining polyethoxy groups being hydrogen capped, the degree of quaternization preferably is more than 90%, most preferably about 100%, and where preferably the water-soluble counter-anion is selected from the group consisting of chlorine, bromine, iodine, methylsulfate, and mixtures thereof, more preferably chloride.

### Ethoxylated Polyethyleneimine

The composition of the invention comprises between 0.5% and 10%, preferably between 1% and 7.5%, more preferably between 2% and 6%, most preferably between 3% and 5% by weight of the liquid detergent composition of an ethoxylated polyethyleneimine.

The ethoxylated polyethyleneimine has an polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600.

The ethoxylation chains within the ethoxylated polyethyleneimine may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain.

The ethoxylation chains within the ethoxylated polyethyleneimine polymer of the present composition have on average 5 to 40, preferably 10 to 30, more preferably 15 to 25, even more preferably 18 to 22, most preferably about 20 ethoxy units per ethoxylation chain.

The ethoxylated polyethyleneimine may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol.

The ethoxylation of the polyethyleneimine backbone preferably includes: (1) one or two ethoxylation modifications per nitrogen atom, dependent on whether the modification occurs at a internal nitrogen atom or at a terminal nitrogen atom, in the polyethyleneimine backbone, the ethoxylation modification consisting of the replacement of a hydrogen atom by a polyethoxylene chain having an average of about 5 to about 40 ethoxy moieties per modification, wherein the terminal alkoxy moiety of the alkoxylation modification is capped with hydrogen, a C₁-C₄ alkyl or mixtures thereof, preferably hydrogen; or (2) an addition of one C₁-C₄ alkyl moiety and one or two ethoxylation modifications per nitrogen atom, dependent on whether the substitution occurs at an internal nitrogen atom or at an terminal nitrogen atom, in the polyethyleneimine backbone, the ethoxylation modification consisting of the replacement of a hydrogen atom by a polyethoxylene chain having an average of about 5 to about 40 ethoxy moieties per modification wherein the terminal ethoxy moiety is capped with hydrogen, a C₁-C₄ alkyl or mixtures thereof, preferably hydrogen; or (3) a combination thereof. According to the present invention the ethoxylation route of the polyethyleneimine described under (1) is preferred.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

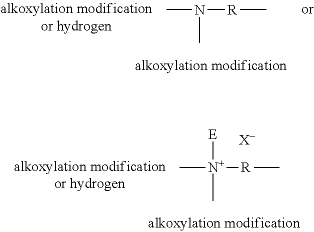

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion.

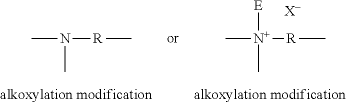

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Most preferably the degree of quaternization is 0%.

A preferred polyethyleneimine has the general structure of formula (I):

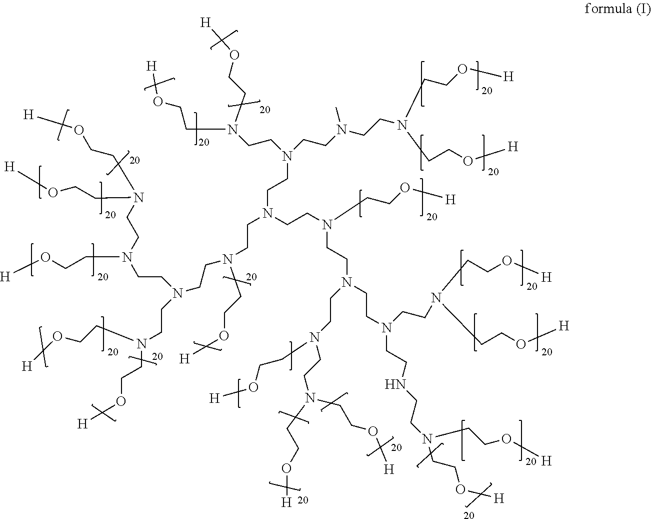

wherein the polyethyleneimine backbone has a weight average molecular weight of about 600 g/mol, n of formula (I) has an average of about 20. Each polyethoxy chain is hydrogen capped. The degree of permanent quaternization of formula (I) is about 0% of the polyethyleneimine backbone nitrogen atoms. The molecular weight of this polyethyleneimine preferably is between 10000 and 15000 g/mol, more preferably about 12700 g/mol.

The described ethoxylated polyethyleneimines can be made using techniques previously described in the art, and as such those skilled in the art would understand how to produce such compounds. These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, followed by an ethoxylations step.

### Water-Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns: 5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-molding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers and/or copolymers can also be used as the pouch material, especially mixtures of polyvinylalcohol polymers and/or copolymers, especially mixtures of polyvinylalcohol homopolymers and/or anionic polyvinylalcohol copolymers preferably selected from sulphonated and carboxylated anionic polyvinylalcohol copolymers especially carboxylated anionic polyvinylalcohol copolymers. Most preferably the water-soluble film comprises a blend of a polyvinylalcohol homopolymer and a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Process of Washing

A further aspect of the present invention is a process for washing fabrics comprising the steps of;
a. Combining a water-soluble unit dose article according to the present invention with sufficient water to dissolve the water-soluble film and dilute the laundry detergent composition by a factor of between 300 and 800-fold to form a wash liquor;
b. Combining the wash liquor with at least one fabric to be washed.

The wash process may be conducted in a hand wash operation, an automatic wash machine operation or a mixture thereof.

### Process of Making

Those skilled in the art will know how to make the unit dose article and laundry detergent composition of the present invention using known techniques in the art.

During manufacture, a first water-soluble film may be shaped to comprise an open compartment into which the detergent composition is added. A second water-soluble film is then laid over the first film in such an orientation as to close the opening of the compartment. The first and second films are then sealed together along a seal region using known sealing means such as solvent, heat or a mixture thereof.

### Examples

A particulate stain removal wash test was performed single variably comparing the stain removal impact of fatty acid in presence of an ethoxylated polyimine soil release polymer compared to in presence of a zwitterionic polyamine reference.

### Particulate Stain Removal Wash Test:

A short cotton cycle at 40° C. and 9 gpg water hardness has been selected on a Miele washing machine (model 3622). Total run time was 90 minutes. 2.5 kg cotton ballast loads (sourced from Warwick Equest Ltd. Unit 55, Consett Business Park, Consett, County Durham, DH8 6BN) were added together with a soiled load (2 SBL2004 soiled ballast sheets ex wfk Testgewebe GmbH Christenfeld 10, D-41379 Brüggen-Bracht Germany order ref 10996) and together with stained cotton test fabrics (sourced from Warwick Equest Ltd. Unit 55, Consett Business Park, Consett, County Durham, DH8 6BN). Test products were added directly into the drum prior to starting the wash cycle. After washing ballast and soiled load and test fabrics were tumble dried in a Miele tumble dryer set to “extra dry”.

The stained cotton test fabrics were washed with one of the test products described below. The results were then analysed by image analysis which is a method that enables to calculate the amount of stain that is removed. Stains are imaged before washing and after washing. The imaging calculates the amount of stain removed, reflected as a stain removal index (SRI—% stain removed). SRI of 100 means complete removal and SRI of zero means no removal.

The Laundry Image Analysis system (Merlin image analysis system) measures stain removal on technical stain swatches. The system utilizes a video camera to acquire colour images of swatches. An image of the swatch is taken before and after it is washed. The acquired image is then analysed by computer software (Procter and Gamble Global R&D computing). The software compares the unwashed stain to the washed stain, as well as the unwashed fabric to the washed fabric. The result is expressed as a stain removal index.

Each stain was duplicated within each wash cycle (2 internal replicates). This test has been repeated 3 times for each test leg (3 external replicates) and the resulting 6 individual stain removal index results were averaged and reported.

### Formula Compositions:

The following water-soluble unit dose laundry compositions were prepared through mixing of the individual components. 18.5 g of Base product was added via a dosing ball in each wash test. Lutensol FP620 (ethoxylated polyimine polymer ex BASF—PEI600EO20) and Lutensit Z96 (zwitterionic polyamine ex BASF—zwitterionic hexamethylene diamine according to below formula: 100% quaternized and about 40% of the polyethoxy (E024) groups are sulfonated) were added on top as 1% solutions in water adjusted to pH 7.5, prepared as described below. Fatty acid was directly added on top of the base product.

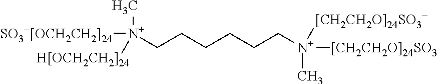

### Preparation of 1% Solutions:

Lutensol FP620: Weigh 12.69 g of 78.8% active Lutensol FP620 into a 600 ml beaker, add 400 ml deionised water and adjust the pH to 7.50 using a pH meter and 0.05N citric acid. Transfer the resulting solution to a 1000 ml flask and add deionized water till 1000 ml.
Lutensit Z96: Weigh 14.49 g of 69% active Lutensit Z96 into a 600 ml beaker, add 400 ml deionised water and adjust the pH to 7.50 using a pH meter and 0.05N citric acid. Transfer the resulting solution to a 1000 ml flask and add deionized water till 1000 ml.

### Base Product:

| | Base product |
|---|---|
| | wt % |
| Propylene 1,2-diol | 8.394 |
| Sodium Laureth Sulfate (68% in water) | 23.975 |
| Brightener 49 | 5.588 |
| Citric acid (50% in water) | 1.582 |
| DiPropyleneGlycol | 16.780 |
| Glycerin | 3.598 |
| Editronic Acid (66% in water) | 2.172 |
| Linear alkylbenzene sulphonic acid | 17.979 |
| Potassium Sulfite (45% in water) | 0.269 |
| Mannanase enzyme | 0.346 |
| Monoethanolamine | 6.622 |
| Nonionic Surfactant (C24EO7) | 1.199 |
| Polymer Sokalan PG101 | 5.109 |
| Perfume | 2.613 |
| Termamyl Ultra Amylase enzyme | 0.157 |
| Protease enzyme | 1.660 |
| Everest 200L Amylase enzyme | 0.157 |
| Water | 1.799 |

### Addition of Actives:

| | Comparative | | Comparative | Comparative |
|---|---|---|---|---|
| | example 1 | Example 1 | example 2 | example 3 |
| | Material | | | |
| | Base + | Base + | Base + | Base + |
| | Lutensol | Lutensol | Lutenzit | Lutensit |
| | FP620 nil | FP620 with | Z96 nil | Z96 with |
| | FA | FA | FA | FA |
| | Gram per | Gram per | Gram per | Gram per |
| | wash | wash | wash | wash |
| Lutensol | 0.6 (added as | 0.6 (added as | — | — |
| FP620 | 60 ml of 1% | 60 ml of 1% | | |
| | solution) | solution) | | |
| Lutensit | — | — | 0.6 (added as | 0.6 (added as |
| Z96 | | | 60 ml of 1% | 60 ml of 1% |
| | | | solution) | solution) |
| Topped Palm | — | 0.9 | — | 0.9 |
| Kernal Fatty | | | | |
| Acid (FA) | | | | |

### Test Results:

The particulate stain removal data summarized in table 1 and 2 below show the stain removal impact of a fatty acid surfactant within example compositions according to the invention comprising ethoxylated polyimine soil release polymer to be bigger than in compara (difference in stain removal: 10.1% vs 8.0%, % improvement in stain removal: 33.0% vs 21.3%).

TABLE 1
% Particulate stain removal in laundry liquid formulation
comprising ethoxylated polyimine soil release polymer

| | | | | % Improve- |
|---|---|---|---|---|
| | Comparative | | Difference in | ment in stain |
| Soil | Example 1 | Example 1 | stain removal | removal |
| Black todd | 56.4 | 65.0 | 8.6 | 15.2 |
| clay | | | | |
| Brown silica | 15.0 | 29.0 | 14.0 | 93.3 |
| sand | | | | |
| Grass | 81.7 | 86.6 | 4.9 | 6.0 |
| Hoover dust | 53.1 | 68.8 | 15.7 | 29.6 |
| Humax Peat | 30.6 | 45.0 | 14.4 | 47.1 |
| NTC clay | 33.2 | 46.3 | 13.1 | 39.5 |
| Average | 38.6 | 48.7 | 10.1 | 33.0 |

TABLE 2
% Particulate stain removal in laundry liquid
formulation comprising a zwitterionic polyamine

| | | | | % Improve- |
|---|---|---|---|---|
| | Comparative | Comparative | Difference in | ment in stain |
| Soil | example 2 | example 3 | stain removal | removal |
| Black todd | 61.1 | 65.9 | 4.8 | 7.8 |
| clay | | | | |
| Brown silica | 22.8 | 33.5 | 10.7 | 46.9 |
| sand | | | | |
| Grass | 83.3 | 86.7 | 3.4 | 4.1 |
| Hoover dust | 59.4 | 71.8 | 12.4 | 20.9 |
| Humax Peat | 34.5 | 47.5 | 13 | 37.7 |
| NTC clay | 37.8 | 49.8 | 12 | 31.7 |
| Average | 42.7 | 50.7 | 8.0 | 21.3 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a laundry detergent composition, wherein said detergent composition comprises;
a. a first polymer selected from an ethoxylated polyethyleneimine, wherein the laundry detergent composition comprises between about 0.5% and about 10% by weight of the laundry detergent composition of the ethoxylated polyethyleneimine; and
b. between about 3% and about 20% by weight of the laundry detergent composition of the fatty acid, neutralised fatty acid soap or a mixture thereof wherein the neutralized fatty acid soap is alkali metal neutralized, amine neutralized or a mixture thereof;
c. between about 10% and about 40% by weight of the laundry detergent composition of a non-soap surfactant; and
wherein said ethoxylated polyethyleneimine is selected from an ethoxylated polyethyleneimine wherein;
the polyethyleneimine backbone has a weight average molecular weight of between about 100 g/mol and about 2000 g/mol;
an average of about 5 to about 40 ethoxy units per ethoxylation chain;
the ethoxylated polyethyleneimine has a total weight average molecular weight of from about 5000 g/mol to about 20000 g/mol;
wherein the terminal ethoxy moiety of the ethoxylation modification is capped with hydrogen, a C₁-C₄ alkyl or mixtures thereof;
the degree of permanent quaternization being from about 0% to about 30% of the polyethyleneimine backbone nitrogen atoms.

2. The water-soluble unit dose article according to claim 1 wherein the laundry detergent composition comprises a zwitterionic polyamine.

3. The water-soluble unit dose article according to claim 1 wherein the fatty acid, neutralized fatty acid soap or mixture thereof is selected from palm kernel fatty acid, coconut fatty acid, rapeseed fatty acid, neutralized palm kernel fatty acid, neutralized coconut fatty acid, neutralized rapeseed fatty acid, or mixture thereof.

4. The water-soluble unit dose article according to claim 1 wherein the non-soap surfactant comprises an anionic surfactant, a non-ionic surfactant or a mixture thereof.

5. The water-soluble unit dose article according to claim 4 wherein the non-soap surfactant comprises a non-ionic surfactant and wherein the laundry detergent composition comprises between about 0% and about 10% by weight of the laundry detergent composition of the non-ionic surfactant, wherein the non-ionic surfactant is selected from alcohol alkoxylate, an oxo-synthesised alcohol alkoxylate, Guerbet alcohol alkoxylates, alkyl phenol alcohol alkoxylates or a mixture thereof.

6. The water-soluble unit dose article according to claim 1 wherein the non-soap surfactant comprises linear alkylbenzene sulphonate and wherein the laundry detergent composition comprises between about 5% and about 20% by weight of the laundry detergent composition of the linear alkylbenzene sulphonate.

7. The water-soluble unit dose article according to claim 1 wherein the non-soap surfactant comprises an alkyl sulphate, alkoxylated alkyl sulphate or a mixture thereof and wherein the laundry detergent composition comprises between about 5% and about 20% by weight of the of the alkyl sulphate, alkoxylated alkyl sulphate or a mixture thereof.

8. The water-soluble unit dose article according to claim 1 comprising between about 10% and about 60% by weight of the laundry detergent composition of a non-aqueous solvent, wherein the non-aqueous solvent is selected from 1,2-Propanediol, glycerol, sorbitol, dipropylene glycol, tripropyleneglycol, or a mixture thereof.

9. The water-soluble unit dose article according to claim 1 comprising between about 0.1% and about 15% by weight of the unit dose article of water.

10. The water-soluble unit dose article according to claim 1 comprising a second polymer selected from amphiphilic graft copolymers, carboxymethyl cellulose, modified carboxymethylcellulose, polyester terephthalate polymers, hydroxyethylecellulose, modified hydroxyethylcellulose or a mixture thereof, and wherein the laundry detergent composition comprises about 0.5% and about 10% by weight of the laundry detergent composition of the second polymer.

11. The water-soluble unit dose article according to claim 1 wherein the water-soluble film comprises polyvinyl alcohol polymer or copolymer.

12. The water-soluble unit dose article according to claim 11 wherein the water-soluble film comprises a blend of polyvinylalcohol polymers and/or polyvinylalcohol copolymers.

13. The water-soluble unit dose article according to claim 12, wherein the blend of polyvinylalcohol polymers and/or polyvinylalcohol copolymers is selected from sulphonated and carboxylated anionic polyvinylalcohol copolymers especially carboxylated anionic polyvinylalcohol copolymers.

14. A process for washing fabrics comprising the steps of;
a. Combining a water-soluble unit dose article according to claim 1 with sufficient water to dissolve the water-soluble film and dilute the laundry detergent composition by a factor of between about 300 and about 800-fold to form a wash liquor;
b. Combining the wash liquor with at least one fabric to be washed.
